(19) United States
(12) Patent Application Publication
(10) Pub. No.: US 2007/0262493 A1
(43) Pub. Date: Nov. 15, 2007

(54) Method for forming a fine embossed pattern on a surface of a fastener member

(75) Inventor: Shih-Sheng Yang, Taipei Hsien (TW)

Correspondence Address: TROXELL LAW OFFICE PLLC, SUITE 1404, 5205 LEESBURG PIKE, FALLS CHURCH, VA, 22041, US

(73) Assignee: Universal Trim Supply Co., Ltd.

(21) Appl. No.: 11/432,612

(22) Filed: May 12, 2006

(51) Int. Cl. B29C 35/08

(52) U.S. Cl. 264/400; 264/482; 264/328.1

(57) ABSTRACT

A method for forming a fine embossed pattern on a surface of a fastener member, wherein a mold core is formed with a mold cavity having a fastener member shape, and a layer of adhesive paper is adhered to an area of the mold cavity desired to be fashioned with an embossed decorative design, then laser engraving machining technology is used to engrave out a specific pattern on the mold cavity. Adhesive paper out of the pattern is removed, and mold texturing (electrodischarge machining) is implemented. Finally, the residual adhesive paper is torn away to reveal a non-textured fine pattern in the mold cavity, and plastic ejection molding is implemented to manufacture a fastener member having a fine embossed pattern, thereby increasing aesthetic appeal of the fastener member.

### BACKGROUND OF THE INVENTION

(a) Field of the Invention

The present invention provides a method for forming a fine embossed pattern on a surface of a fastener member, which incorporates texturing (electrodischarge machining) to the surface of a molded cavity to produce a specific pattern, thereby enabling a surface of an injection molded fastener member to have a decorative design with increased aesthetic appeal.

(b) Description of the Prior Art

Fastener members have extensive application in articles of daily use, such as clothing, backpacks, and so on, and the forms and varieties used in the current market are innumerable. Moreover, because of the increase in the quality of life of people, there has been a corresponding increase in the demand for quality in goods. However, regarding the design aspect of prior art fastener members, there is no area for significant variation in the production of external form, color and texture of decorative designs.

Hence, in light of the aforementioned, the inventor of the present invention, having accumulated years of design development experience in related arts, attentively and circumspectly carried out extensive study and exploration to ultimately provide a method to more positively embellish the fastener members and increase their aesthetic appeal so as to improve the distinguishing characteristics of the fastener members, thereby increasing added value to relevant products that use the fastener members for the use by consumers and the general public.

### SUMMARY OF THE INVENTION

A primary objective of the present invention is to provide a method for forming a fine embossed pattern on a surface of a fastener member, using laser engraving machining technology, an adhesive layer combined with mold texturing to produce a specific fine embossed pattern on a surface of an injection molded fastener member, thereby increasing aesthetic appeal thereof.

Another objective of the present invention is to provide the method for forming a fine embossed pattern on a surface of a fastener member with enhanced distinguishing characteristics, thereby increasing added value of the product using such fastener members.

In order to achieve the aforementioned objectives, steps to implement the method for forming a fine embossed pattern on a surface of a fastener member are as follows:

(a) Fabricating a mold core: A fashioned mold core is manufactured.

(b) Adding adhesive paper to the mold cavity: A layer of adhesive paper is adhered to the desired machining portion in a mold cavity.

(c) Laser cutting a specific pattern: Laser engraving machining technology is used to engrave out a specific pattern of any shape on the adhesive paper on the surface of the mold cavity.

(d) Removing unwanted rim of the pattern: Surplus adhesive paper of the pattern is removed, with the pattern portion retained.

(e) Implementing mold texturing: A decorative design is etched out on the portion out of the pattern to form a matt surface.

(f) Removing residual adhesive paper: The residual adhesive paper within the mold cavity is torn away.

(g) Completing a mold core with the surface having a decorative design: A non-textured bright surface in the mold cavity with fine patterned decorative design is revealed.

(h) Implementing plastic ejection molding: An injection molding machine using the finished mold is employed to manufacture a fastener member, thereby obtaining the fastener member with increased aesthetic appeal.

To enable a further understanding of said objectives and the technological methods of the invention herein, brief description of the drawings is provided below followed by detailed description of the preferred embodiments.

### BRIEF DESCRIPTION OF THE DRAWINGS

FIG. 1 shows a block flow diagram depicting a manufacturing method according to the present invention.

FIG. 2 shows a schematic view of processing step (a) according to the present invention.

FIG. 3 shows a schematic view of processing steps (b) and (c) according to the present invention.

FIG. 4 shows a schematic view of processing steps (d) and (e) according to the present invention.

FIG. 5 shows a schematic view of processing steps (f), (g) and (h) according to the present invention.

### DETAILED DESCRIPTION OF THE PREFERRED EMBODIMENTS

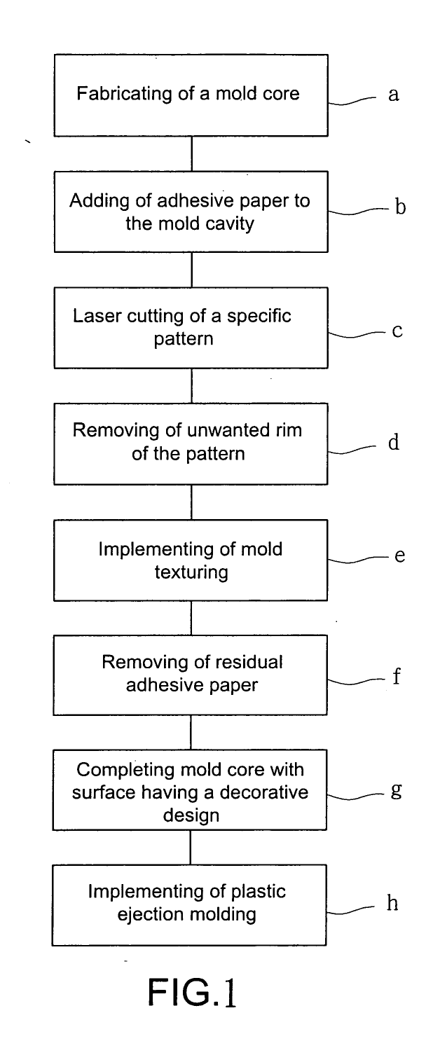

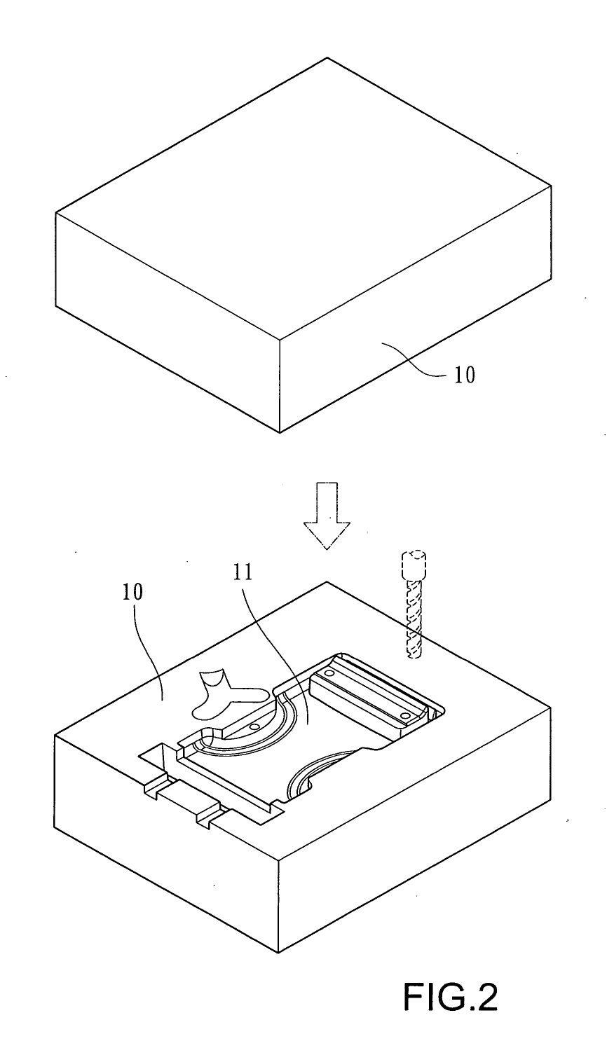

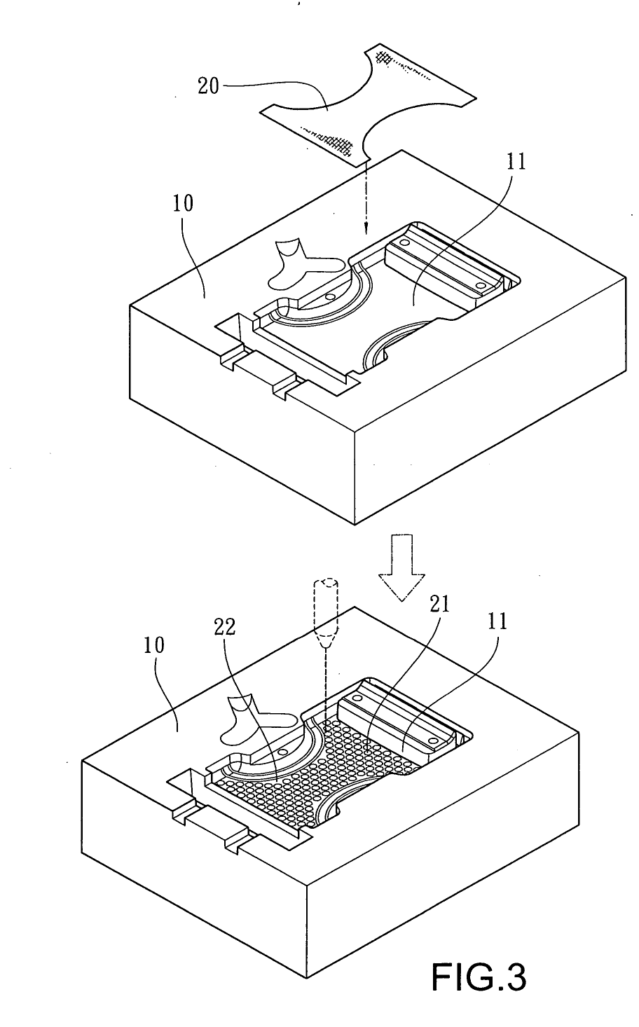

Referring to FIG. 1, which shows a block flow diagram of a manufacturing method of the present invention, and in conjunction with FIGS. 2, 3 4 and 5, particular steps involved to the manufacturing method of the present invention are as described hereinafter:

(a) Fabricating a mold core: A mold core 10 is first manufactured, and a machine tool is used to implement milling and electrodischarge machining to produce a mold cavity 11 having a contour shaped smooth (mirror) surface of a fastener member (see FIG. 2).

(b) Adding adhesive paper to the mold cavity: One layer of an adhesive paper 20 is adhered inside the mold cavity 11 to make apparent the desired machining portion of a plane surface with fine heights and drops or cambered surface (see FIG. 3).

(c) Laser cutting a specific pattern: A specific pattern 21 (which can be of any geometric form, including circular, triangular, quadrangular and polygonal form) is engraved out of the adhesive paper 20 on the surface of the mold cavity 11 using laser engraving machining technology, and machining is carried out by setting depth sectioning of the laser machining head according to the working face of different heights (see FIG. 3).

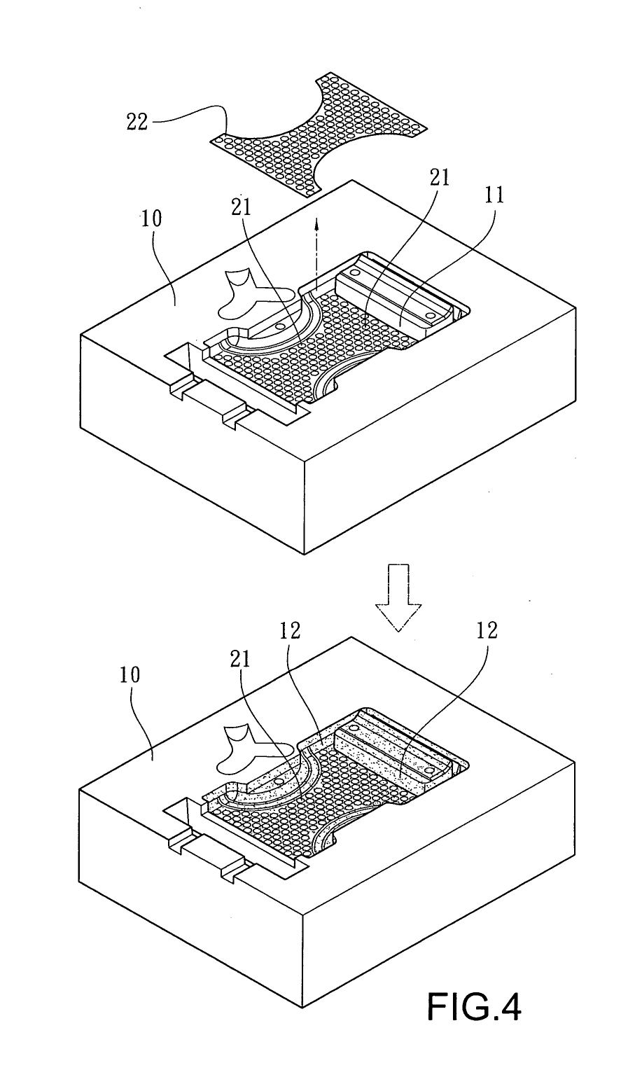

(d) Removing unwanted rim of the pattern: Adhesive paper from rim 22 portion out of the pattern 21 is manually removed, retaining the pattern 21 portion within the mold cavity 11 (see FIG. 4).

(e) Implementing mold texturing: Mold texturing is implemented in the mold cavity 11 whereby a decorative design is etched out on the extra rim 22 portion of the pattern 21 forming a matt surface 12, wherein etching depth is approximately between 0.2 and 0.5mm (see FIG. 4).

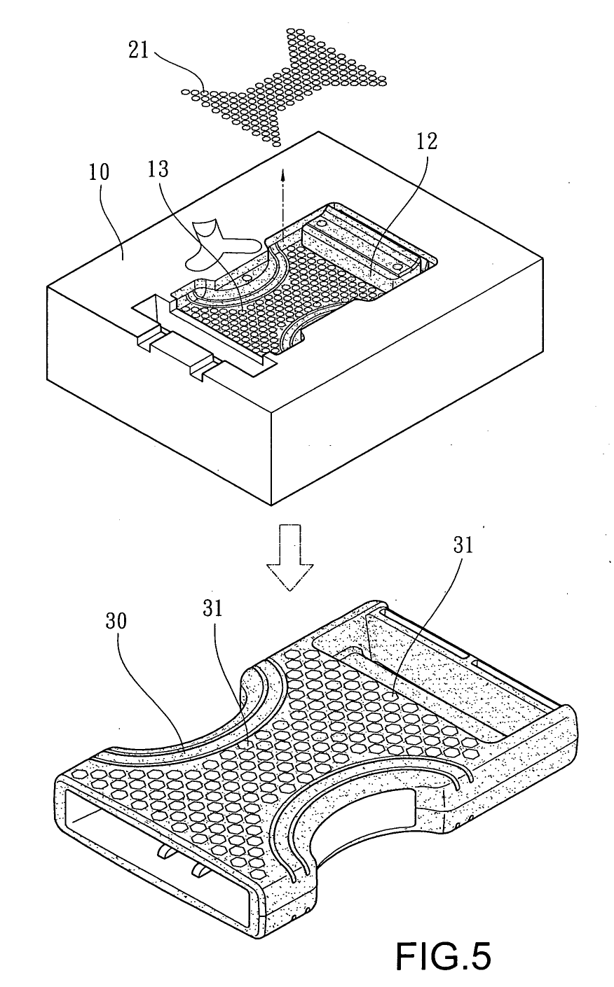

(f) Removing residual adhesive paper: The adhesive paper of the pattern 21 portion previously retained in the mold cavity 11 is torn away (see FIG. 5).

(g) Completing a mold core with the surface having a decorative design: A decorative design 13 provided with a bright (mirror) surface within the mold cavity 11 is revealed after tearing away the residual adhesive paper within the mold cavity 11 (see FIG. 5).

(h) Implementing plastic ejection molding: An ejection molding machine using the fabricated mold core 10 is employed to produce a fastener member 30 having a surface with a fine embossed pattern 31.

Accordingly, a fastener member having aesthetic appeal can be created employing the aforementioned method, which increases the distinguishing characteristics of the fastener member, thereby increasing added value to relevant products that use the fastener members. Under the same principle, when the mold core forms a recess for a molded button or zipper accessory tab, application of the aforementioned manufacturing process can be similarly used to manufacture products having a surface with the fine embossed pattern 31.

In conclusion, according to the aforementioned disclosures, the present invention clearly achieves effectiveness of anticipated advancement, and provides the method for forming a fine embossed pattern on a surface of a fastener member. Moreover, practicability and advancement of the present invention clearly comply with essential elements as required for a new patent application. Accordingly, a new patent application is proposed herein.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A method for forming a fine embossed pattern on a surface of a fastener member, comprising the following steps:
(a) fabricating a mold core: a mold core having a shape of a fastener member is manufactured;
(b) adding adhesive paper to the mold cavity: a layer of adhesive paper is adhered to the desired machining portion in a mold cavity;
(c) laser cutting a specific pattern: laser engraving machining technology is used to engrave out a specific pattern on the adhesive paper on the surface of the mold cavity;
(d) removing unwanted rim of the pattern: surplus adhesive paper of the pattern is removed, with the pattern portion retained;
(e) implementing mold texturing: a decorative design is etched out on the extra portion out of the pattern to form a matt surface;
(f) removing residual adhesive paper: the residual adhesive paper within the mold cavity is torn away;
(g) completing a mold core with the surface having a decorative design: a non-textured bright surface in the mold cavity with fine patterned decorative design is revealed;
(h) implementing plastic ejection molding: an injection molding machine using the finished mold is employed to manufacture a fastener member having a surface of fine embossed pattern.

2. The method for forming a fine embossed pattern on a surface of a fastener member according to claim 1, wherein the pattern engraved in processing step (c) can be in any geometric form, including circular, triangular, quadrangular and polygonal form.

3. The method for forming a fine embossed pattern on a surface of a fastener member according to claim 1, wherein the laser machining of processing step (c) is implemented by setting depth sectioning of the laser machining head according to the working face of different heights.

4. The method for forming a fine embossed pattern on a surface of a fastener member according to claim 1, wherein the etching depth of the mold texturing of processing step (e) is approximately between 0.2 and 0.5 mm.

5. The method for forming a fine embossed pattern on a surface of a fastener member according to claim 1, wherein the mold cavity formed in the mold core during fabrication of the mold core of processing step (a) can be in the form of a button.

6. The method for forming a fine embossed pattern on a surface of a fastener member according to claim 1, wherein the mold cavity formed in the mold core during fabrication of the mold core of processing step (a) can be in the form of a decorative zipper tab.
